(19) United States
(12) Patent Application Publication
(10) Pub. No.: US 2009/0294723 A1
(43) Pub. Date: Dec. 3, 2009

(54) Rubber composition for magnetic encoder and magnetic encoder using the same

(76) Inventor: Yoshihiko Yamaguchi, Okayama (JP)

Correspondence Address: WENDEROTH, LIND & PONACK, L.L.P., 1030 15th Street, N.W.,, Suite 400 East, Washington, DC, 20005-1503, US

(21) Appl. No.: 12/461,291

(22) Filed: Aug. 6, 2009

Related U.S. Application Data
(63) Continuation of application No. 12/073,320, filed on Mar. 4, 2008, now abandoned.
Application No. 12/073,320 is a continuation of application No. 11/342,647, filed on Jan. 31, 2006, now abandoned.

(30) Foreign Application Priority Data
Jan. 1, 2005 (JP) 2005-025647

(51) Int. Cl. H01F 1/00; H01F 1/053

(52) U.S. Cl. 252/62.54

(57) ABSTRACT

The invention provides a rubber composition for a magnetic encoder being excellent in durability such as heat resistance, oil resistance and chemical resistance, having high magnetic characteristics and being excellent in processability and a magnetic encoder using the rubber composition. The magnetic rubber composition for the magnetic encoder includes a fluorinated rubber with a Mooney viscosity (ML1+10, 121° C.) of 20 to 100 and a magnetic powder, and the magnetic powder is blended in a proportion of 230 to 1900 parts by weight relative to 100 parts by weight of the fluorinated rubber. The magnetic encoder is provided by vulcanizing and molding the rubber composition.

### BACKGROUND OF THE INVENTION

1. Field of the Invention

The invention relates to a rubber composition for a magnetic encoder, and a magnetic encoder using the same. Specifically, the invention relates to a magnetic rubber composition for a magnetic encoder that has a high magnetic force and is improved in heat resistance, oil resistance and chemical resistance. Also, the invention relates to a magnetic encoder using said magnetic rubber composition for a magnetic encoder.

2. Description of the Related Art

A rubber magnet for use in sensors is used in a magnetic encoder for use in rotation speed sensors.

Among rotation speed sensors, a rubber magnet is used for magnetic encoder parts in a wheel speed sensor of motor vehicles, and nitrile rubber (NBR) or hydrogenated nitrile rubber (HNBR) is usually used in the rubber component. The rubber is described in claims and embodiments in International Patent Publication No. WO 01/041162.

However, applications of NBR having an upper limit of the heat resistant temperature of about 120° C. and HNBR having an upper limit of the heat resistant temperature of about 140° C. to around automobile engines are restricted, since the temperature of the environment where the rubber is used is as high as 130 to 170° C.

While silicone rubber, acrylic rubber, and the like can be used at about 130 to 170° C., silicone rubber is poor in oil resistance. On the other hand, release of a molded acrylic rubber is difficult when a magnetic powder is filled in a high concentration, and the die is evidently contaminated to cause poor processability.

The rotation speed sensor is used not only for the wheel speed sensor, but also for various uses such as a rotation angle sensor of a steering, a shaft rotation motor of, for example, an electric motor and a flow rate control sensor of, for example, a pump.

Accordingly, it is desirable for the rubber magnet for the sensor to have a high residual magnetic flux density. A higher residual magnetic flux density of the rubber magnet for the sensor permits the distance between the sensor and encoder to be large. Since the large distance allows the tolerance of assembly for assembling a system to be large, freedom of design is enhanced to make various applications as described above to be more advantageous.

However, although it is possible in the rubber ferrite using conventional ferrites to increase the residual magnetic flux density by increasing the amount of filling of the ferrite, hardness of the rubber also increases when the amount of filling of the ferrite is too large to cause a remarkable decrease in processability.

An attempt to increase heat resistance causes a decrease in oil resistance, or an attempt to obtain good magnetic characteristics leads to poor processability in the conventional rubber composition for the magnetic encoder and in the magnetic encoder using the rubber composition. The conventional rubber composition for the magnetic encoder and magnetic encoder using the composition have not always been satisfactory in terms of heat resistance, oil resistance, magnetic characteristics as the magnetic encoder, and processability.

### SUMMARY OF THE INVENTION

Accordingly, an object of the present invention is to provide a rubber composition for the magnetic encoder being excellent in durability such as heat resistance, oil resistance and chemical resistance as well as in magnetic characteristics while the rubber composition has good processability. And another object of the present invention is to provide a magnetic encoder using said rubber composition, so that it is excellent in durability such as heat resistance, oil resistance and chemical resistance as well as in magnetic characteristics.

In order to solve the above problems, a rubber composition for a magnetic encoder according to the present application includes a fluorinated rubber with a Mooney viscosity (ML1+10, 121° C.) of 20 to 100 and a magnetic powder, while the magnetic powder is blended in a proportion of 230 to 1900 parts by weight relative to 100 parts by weight of the fluorinated rubber.

The before described rubber composition for the magnetic encoder of the present invention using the fluorinated rubber (FKM) is excellent in durability such as heat resistance, oil resistance and chemical resistance.

The fluorinated rubbers (FKM) that can be used are any copolymer rubbers represented by binary polymers including vinylidene fluoride and hexafluoropropylene, and by ternary polymers including at least three components selected from vinylidene fluoride, hexafluoropropylene, tetrafluoroethylene, perfluoromethyl vinylether and other commonly used copolymerizable fluorinated compounds.

For example, various commercially available products such as elastomer E430 (trade name, manufactured by Dupont-Dow Co.), and DAI-EL G-712, DAI-EL G-714, DAI-EL G-716 and DAI-EL LT-302 (trade names, manufactured by Daikin Industries, Ltd.) may be directly used as fluorinated rubber included in the rubber composition for a magnetic encoder of the present invention, provided that it has a Mooney viscosity (ML1+10, 121° C.) of 20 to 100.

The fluorinated rubber used for the rubber composition for the magnetic encoder of the present invention is excellent in mold processability due to large fluidity of the rubber composition when the Mooney Viscosity is lower. However, contamination of the die at the time of molding becomes evident when the Mooney viscosity (M1+10, 121° C.) is less than 20 to decrease productivity. Processing such as kneading work becomes remarkably difficult, on the other hand, when the Mooney viscosity (M1+10, 121° C.) exceeds 100. Accordingly, the rubber composition for the magnetic encoder excellent also in processability can be provided by using a fluorinated rubber with a Mooney viscosity (M1+10, 121° C.) of 20 to 100.

While vulcanization systems of fluorinated rubber are roughly classified into a polyol vulcanization system and peroxide vulcanization system, any of the systems may be selected.

Since a magnetic powder is blended to the rubber composition for the magnetic encoder of the present invention in a proportion of 230 to 1900 parts by weight relative to 100 parts by weight of the fluorinated rubber, it has excellent magnetic characteristics with a high residual magnetic flux density.

It is further preferable to blend the magnetic powder in the proportion of 400 to 1000 parts by weight relative to 100 parts by weight of the fluorinated rubber in order to allow the rubber composition to have more excellent processability as well as more excellent magnetic characteristics.

Ferrite magnet powders with a particle diameter of about 0.5 to 100 μm or rare earth magnet powders with a particle diameter of about 0.5 to 100 μm may be used as the magnetic powder used in the rubber composition of the magnetic encoder of the present invention. The particle diameter of these magnetic powders may be further reduced by re-pulverization before subjecting the powder to kneading, or the surface of the powder may be treated with a silane coupling agent, titanate coupling agent, higher fatty acid or other conventionally used surface treatment agents for enhancing compatibility with the rubber.

The rare earth magnet powder is desirably used as the magnetic powder from the view point of magnetic force. Using the rare earth magnet powder as the magnetic powder permits the residual magnetic flux density to be higher and a rubber composition for the magnetic encoder having more excellent magnetic characteristics to be provided.

When the rare earth magnet powder is used as the magnetic powder as the before described, magnet powder including at least neodymium-iron-boron magnet powder may be used. That is to say, the rare earth magnet powder including a neodymium-iron-boron magnet powder and the other rare earth magnet powder, or a rare earth magnet powder including only the neodymium-iron-boron magnet powder may be used as the before described rare earth magnet powder.

Also, when the rare earth magnet powder is used as the magnetic powder as the before described, magnet powder including at least samarium-iron-nitrogen magnet powder may be used. That is to say, the rare earth magnet powder including a samarium-iron-nitrogen magnet powder and the other rare earth magnet power, or a rare earth magnet powder including only the samarium-iron-nitrogen magnet powder may be used as the before described rare earth magnet powder.

A magnet powder including at least the neodymium-iron-boron magnet powder or a magnet powder including at least the samarium-iron-nitrogen magnet powder can be used as a rare earth magnet powder because these magnetic powders are excellent in the production cost and processability.

Since the samarium-iron-nitrogen magnet powder is excellent in corrosion resistance and has smaller temperature changes of magnetic characteristics as compared with the neodymium-iron-boron magnet powder, the former is particularly suitable to be used as the rare earth magnet powder.

The neodymium-iron-boron magnet powder and samarium-iron-nitrogen magnet powder include an anisotropic magnet powder exhibiting magnetic anisotropy, and an isotropic magnet powder exhibiting no magnetic anisotropy. While any one of the magnetic powders may be selected as the rubber composition for the magnetic encoder of the invention, selecting the isotropic magnet powder is preferable because it is advantageous with respect to magnetization.

In the before described rubber compositions for the magnetic encoder of the present invention, it is preferable that the residual magnetic flux density is 300 mT or more.

The rubber composition for the magnetic encoder having a residual magnetic flux density of 300 mT or more is advantageous for exhibiting high magnetic characteristics.

The before described rubber compositions for the magnetic encoder of the invention may include, in addition to the above described components, that is to say, in addition to the essential component comprising fluorinated rubber with a Mooney viscosity (ML1+10, 121° C.) of 20 to 100 and a magnetic powder, other additives such as a reinforcing agent represented by silica and carbon black, a coupling agent, an anti-aging agent, a plasticizer, a processing assistant, a cross-linking assistant, an acid receptor and a cross-linking accelerating agent, may be added if necessary as it is used in this art.

In the before described rubber compositions for the magnetic encoder of the present invention, the magnetic powder and the fluorinated rubber are used as the essential components as the before described. And while the magnetic powder is blended in a proportion of 230 to 1900 parts by weight, more preferably in a proportion of 400 to 1000 parts by weight, relative to 100 parts by weight of the fluorinated rubber in the rubber composition for the magnetic encoder of the present invention, the rubber composition for the magnetic encoder of the present invention may be obtained by appropriately adding the other components used in the art to the essential components as described above.

Accordingly, in the before described rubber compositions for the magnetic encoder of the present invention, the magnetic powder is desirably blended to the rubber composition for the magnetic encoder of the present invention in a proportion of 70 to 95% percent by weight. If a proportion of the magnetic powder is less than 70% percent by weight in the rubber composition for the magnetic encoder, the residual magnetic flux density, or the magnetic force as the magnetic encoder becomes poor even when the magnetic powder is blended in a proportion of 230 to 1900 parts by weight, more preferably in a proportion of 400 to 1000 parts by weight, relative to 100 parts by weight of the fluorinated rubber. Also, if a proportion of the magnetic powder is larger than 95% percent by weight in the rubber composition for the magnetic encoder, on the other hand, the processability such as kneading and molding becomes extremely poor and flexibility of the vulcanization product is impaired.

So that, in the before described rubber compositions for the magnetic encoder of the present invention, the magnetic powder is desirably blended to the rubber composition for the magnetic encoder of the present invention in a proportion of 70 to 95% percent by weight.

The rubber composition for the magnetic encoder of the present invention can be obtained by kneading the components as described above using, for example, a hermetic kneader and an open roll.

The magnetic encoder proposed in the invention for solving the problems as described above is produced from the before described essential component comprising fluorinated rubber with a Mooney viscosity (ML1+10, 121° C.) of 20 to 100 and a magnetic powder, and the before described other additives using in this art by molding and vulcanization.

For example, the vulcanization and molding process includes the steps of kneading the components of the rubber composition for the magnetic encoder of the present invention using a hermetic kneader and an open roll, and forming cross-links by injection molding, compression molding or transfer molding of the kneaded product at about 150 to 250° C. for about 0.2 to 60 minutes. The residual magnetic flux density may be further enhanced by forming the cross-links in a magnetic field. A molded product that has been cross-linked may be cross-linked again by treating at about 150 to 250° C. for about 0.5 to 72 hours.

A metal plate such as a stainless steel plate and cold roll steel plate may be used, if necessary, as a supporting ring of the magnetic encoder at the time of vulcanization and molding. Since the magnetic encoder is bonded by cross-linking, an adhesive such as a commercially available phenol resin, epoxy resin or silane resin is preferably coated on the bonding surface of the metal plate in advance.

As hitherto described, the rubber composition for the magnetic encoder of the invention is excellent in durability such as heat resistance, oil resistance and chemical resistance with high magnetic characteristics and good processability. Accordingly, the vulcanized and molded magnetic encoder of the invention is also excellent in durability such as heat resistance, oil resistance and chemical resistance with high magnetic characteristics and good processability.

Consequently, the magnetic encoder of the invention is suitable for use in the rotation speed sensor.

As described in detail above, the invention provides a rubber composition for a magnetic encoder and the magnetic encoder being excellent in durability such as heat resistance, oil resistance and chemical resistance while the composition has high magnetic characteristics and good processability.

### BRIEF DESCRIPTION OF THE DRAWINGS

FIG. 1 is a partially cut and partially omitted perspective view of the magnetic encoder of the invention bonded to a supporting ring by vulcanization and molding;

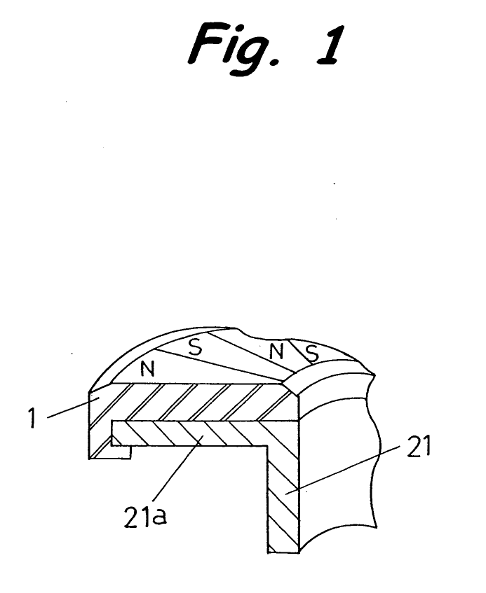

FIG. 2 is a partially omitted cross-sectional view of the magnetic encoder of the invention, wherein the magnetic encoder bonded to the supporting ring shown in FIG. 1 by vulcanizing and molding composes a hermetic device having the encoder in combination with an annular seal element; and

FIG. 3 is a partially omitted cross-sectional view illustrating a state in which the magnetic encoder of the invention is used as a rotation speed sensor by combining the hermetic device having the encoder shown in FIG. 2 with a rotation detecting sensor.

### DESCRIPTION OF THE PREFERRED EMBODIMENTS

Rubber compositions for a magnetic encoder of the invention in Examples 1 to 5, and rubber compositions for a magnetic encoder in Comparative Examples 1 to 3 were evaluated as follows. The compositions, production methods and evaluation methods in Examples 1 to 5 and Comparative Examples 1 to 3 are shown below.

### Example 1

Fluorinated rubber (trade name; elastomer E430, manufactured by Dupont Dow Co., Mooney viscosity (ML1+10, 121° C.)=31):100 parts by weight Neodymium-iron-boron magnet powder (trade name; MQP-B, manufactured by MQI Co.):500 parts by weight

Higher fatty acid ester (trade name; Glec G8205, manufactured by Kao Corporation):2 parts by weight

Plasticizer (trade name; RS700, manufactured by Asahi Denka Co., Ltd.):5 parts by weight

Vulcanization assistant (trade name; Rhenofit CF, manufactured by Rhein Chemie):6 parts by weight

Acid receptor (trade name; Kyowa Mag, manufactured by Kyowa Chemical Industry Co., Ltd.):2 parts by weight

The components above were kneaded using a hermetic kneader and an open roll, and the kneaded product was compression-molded at 170° C. for 5 minutes followed by cross linking again at 230° C. for 24 hours to obtain a cross-linked sheet with a thickness of 2 mm.

The vulcanized sheet was measured with respect to the following items:

ordinary state property: according to JIS K6251 and 6253;

air heating aging test: according to JIS K6257 (150° C.×70 hr);

oil immersion test: according to JIS K6256 (IRM 903 oil, 150° C.×70 hr); and magnetic characteristics test: residual-magnetic flux density measured with a direct current magnetization meter (manufactured by Metron Inc.).

### Example 2

The cross-linked sheet was produced by the same method as in Example 1, except that 800 parts by weight of the magnet powder was used in place of using 500 parts by weight of the magnetic powder, and the sheet was measured as described above.

### Example 3

The cross-linked sheet was produced by the same method as in Example 1, except that the same quantity of HSB-PA (trade name, samarium-iron-nitrogen magnet powder manufactured by Neomax Co., Ltd.) was used in place of the neodymium-iron-boron magnetic powder (trade name MQP-B, manufactured by MQI Co.) used in Example 1, and the sheet was measured as described above

### Example 4

The cross-linked sheet was produced by the same method as in Example 1, except that the same quantity of DAI-EL G-716 (trade name, manufactured by Daikin Industries, Ltd.; (ML1+10, 121° C.)=45) was used as the fluorinated rubber, and the sheet was measured as described above

### Example 5

Fluorinated rubber (trade name; elastomer product E430, manufactured by Dupont-Dow Co., Mooney viscosity (ML1+10, 121° C.)=31): 100 parts by weight

Strontium ferrite powder (trade name; FS-317, manufactured by Toda Kogyo Corp.):500 parts by weight

Higher fatty acid ester (trade name; Glec G8205, manufactured by Kao Corporation):2 parts by weight

Plasticizer (trade name; RS700, manufactured by Asahi Denka Co., Ltd.):5 parts by weight

Vulcanization assistant (trade name; Rhenofit CF, manufactured by Rhein Chemie):6 parts by weight

Acid receptor (trade name; Kyoawa Mag 150, manufactured by Kyowa Chemical Industry Co., Ltd.):2 parts by weight

A cross-linked sheet was produced using the components above in the same manner as in Example 1, and the sheet was measured as described above.

### Comparative Example 1

The cross-linked sheet was produced by the same method as in Example 1, except that FOR-423 (trade name, manufactured by Ausimont Co.; Mooney viscosity (KL1+10, 121° C.)=16) was used as the fluorinated rubber, and the sheet was measured as described above.

### Comparative Example 2

The cross-linked sheet was produced by the same method as in Example 5, except that 500 parts by weight of the strontium ferrite powder used in Example 5 was changed to 250 parts by weight of the strontium ferrite powder, and the sheet was measured as described above. The weight proportion of the magnetic power in the magnetic rubber composition was 68%.

### Comparative Example 3

Nitrile rubber (trade name; N220SH, manufactured by JSR Corporation): 100 parts by weight

Strontium ferrite powder (trade name; FS-317, manufactured by Toda Kogyo Corp.):700 parts by weight

Stearic acid: 2 parts by weight

Anti-aging agent (trade name; Noclac CD):2 parts by weight

Plasticizer (trade name; RS700, manufactured by Asahi Denka Co., Ltd.):5 parts by weight

Activated zinc oxide: 5 parts by weight

Sulfur: 1 part by weight

Vulcanization accelerating agent (trade name; Nocseller CZ, manufactured by Ouchi Shinko Chemical Industrial Co., Ltd.):2 parts by weight

Vulcanization accelerating agent (trade name; Nocseller TT, manufactured by Ouchi Shinko Chemical Industrial Co., Ltd.):2 parts by weight

Vulcanization assistant (trade name; Rhenofit CT, manufactured by Rhein Chemie):6 parts by weight

Acid accepting agent (trade name; Kyowa Mag, Manufactured by Kyowa Chemical Industry Co., Ltd.):2 parts by weight

The components above were kneaded as in Example 1, and the kneaded product was compression-molded at 180° C. for 5 minutes to obtain a cross-linked sheet with a thickness of 2 mm. The sheet was measured as described above.

The results of evaluation in Examples and Comparative Examples are shown in Table 1 below.

TABLE 1

| | | Example | | | | | Comparative Example | | |
|---|---|---|---|---|---|---|---|---|---|
| | | 1 | 2 | 3 | 4 | 5 | 1 | 2 | 3 |
| Ordinary State | Hardness (pts, D) | 45 | 58 | 46 | 46 | 65 | 42 | 32 | 48 |
| Property | Tensile Strength (MPa) | 5.1 | 6.9 | 5.9 | 5.6 | 8.2 | 4.6 | 3.1 | 4.4 |
| | Elongation (%) | 38 | 19 | 36 | 35 | 28 | 16 | 160 | 18 |
| Air Heating Aging | Rate of Change of | ±0 | +1 | ±0 | ±0 | +1 | ±0 | +4 | +21 |
| Test | Hardness (pts) | | | | | | | | |
| | Rate of Change of Tensile | +10 | +9 | +8 | +9 | +33 | +6 | +28 | −19 |
| | Strength (%) | | | | | | | | |
| | Rate of Change of | −7 | −5 | −4 | −6 | −11 | −4 | −14 | −88 |
| | Elongation (%) | | | | | | | | |
| Oil Resistance | Rate of Change of | −3 | −2 | −3 | −3 | −4 | −4 | −6 | +17 |
| Test | Hardness (pts) | | | | | | | | |
| (IRM 903) | Rate of Change of Tensile | +10 | +9 | +9 | +7 | +11 | +3 | +4 | −46 |
| | Strength (%) | | | | | | | | |
| | Rate of Change of | +10 | +6 | +3 | +1 | +3 | ±0 | −13 | −76 |
| | Elongation (%) | | | | | | | | |
| | Rate of Volumetric | +0.3 | −0.1 | +0.4 | +0.2 | −0.5 | +0.3 | +0.8 | +2.3 |
| | Change | | | | | | | | |
| Magnetic | Residual Magnetic Flux | 340 | 460 | 340 | 340 | 220 | 340 | 120 | 210 |
| Characteristics | Density (mT) | | | | | | | | |

| | | | | | | | | |
|---|---|---|---|---|---|---|---|---|
| Contamination of Die | No | No | No | No | No | Yes | No | No |

The samples in Examples 1 to 4 had small rates of change in the air heating aging test and oil resistance test without any contamination and with good processability.

The sample in Example 5 using the strontium ferrite as the magnetic powder was inferior to the samples in Examples 1 to 4 in which the rare earth magnet powder was used as the magnetic powder with respect to magnetic characteristics.

The sample in Comparative Example 1 in which a fluorinated rubber having a low Mooney viscosity was not satisfactory with respect to contamination of the die.

The sample in Comparative Example 2, in which the proportion of blending of the magnetic powder in the rubber composition was as low as 68% relative to the sample in Example 5, had particularly low magnetic characteristics.

The rate of change of elongation in the air heating aging test was large in the sample in Comparative Example 3 using nitrile rubber, and heat resistance was poor.

### Example 6

The magnetic encoder of the invention was produced as follows by vulcanizing and molding the rubber composition for the magnetic encoder of the invention prepared in Example 1.

The rubber composition for the magnetic encoder of the invention prepared in Example 1, and a supporting ring 21 made of a stainless steel plate and having an approximately L-shaped cross section were placed in a mold, and an annular molded rubber was bonded to an annular part 21a of the supporting ring 21 by vulcanization molding. Then, the annular molded rubber was magnetized so that N-poles and S-poles are alternately distributed in the direction of the circumference of the molded rubber, and the magnetic encoder having a magnetic ring 1 attached to a reinforcing ring 21 was obtained.

It is also possible to obtain the magnetic encoder of the invention by vulcanizing and molding the rubber composition for the magnetic encoder of the invention prepared in Example 1 into an annular shape, and by magnetizing the molded rubber so that N-poles and S-poles are alternately distributed in the direction of the circumference of the molded rubber. The magnetic encoder thus obtained may be used by bonding it to the annular part 21a of the metallic supporting ring 21 having an approximately L-shape using an adhesive.

An example in which the magnetic encoder of the invention is used for the rotation speed sensor will be described below.

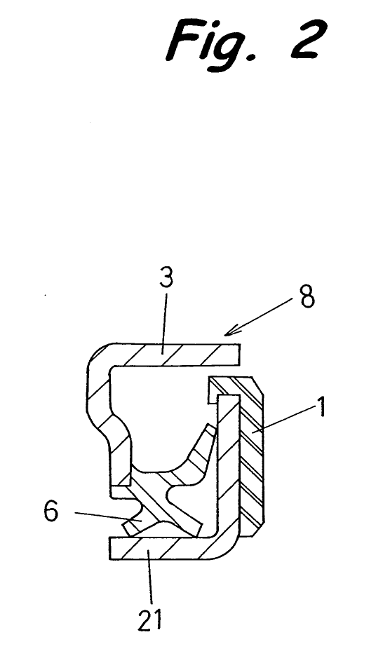

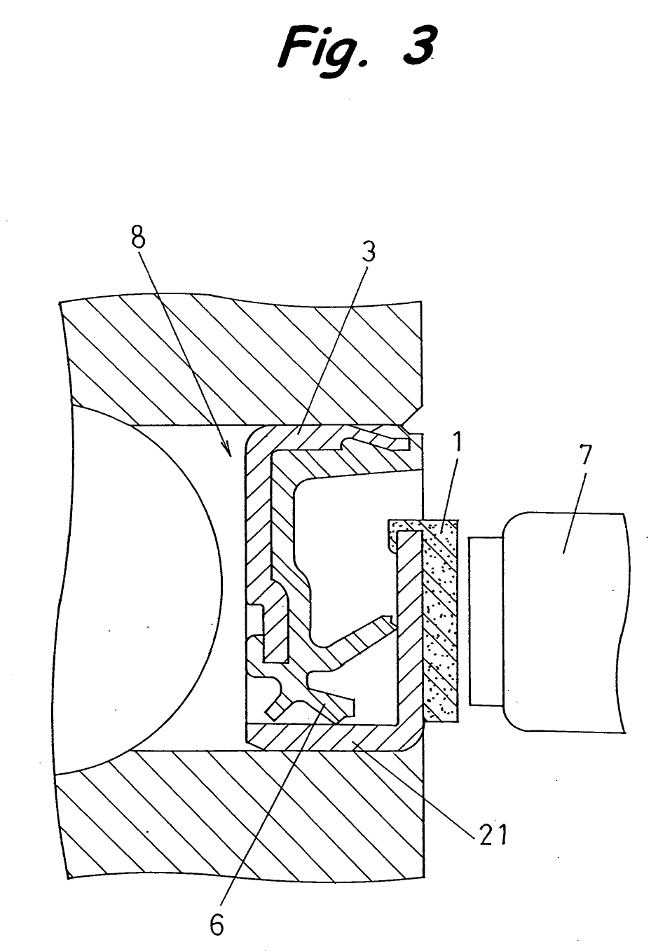

The magnetic encoder prepared as described above was assembled with a seal element 8 in which a lip part 6 including an elastic material such as a synthetic rubber was supported on the metallic reinforcing ring 3 having an approximately L-shape as shown in FIG. 2. The magnetic encoder was disposed on a rotating member such as a bearing shaft as a hermetic device having the encoder as shown in FIG. 3. A rotation detection sensor 7 is disposed in the vicinity of the magnetic encoder so as to be opposed to the surface of the magnetic encoder including the magnetic ring 1 as shown in FIG. 3. In the illustrated embodiment, the magnetic encoder including the magnetic ring 1 rotated together with the rotation of the rotating member of the bearing shaft, and the rotation speed is detected by sensing the pulses generated from the magnetic ring 1 with the rotation detection sensor 7.

Since the magnetic encoder of the invention has a high residual magnetic flux density, the distance between the rotation detection sensor 7 and the magnetic encoder including the magnetic ring 1, or the distance represented in the horizontal direction in FIG. 3, may be increased. Since tolerance of assembly for assembling the system can be increased by this large distance, freedom of design is increased to make it advantageous to apply the magnetic encoder to various uses.

What is claimed is:

1. A rubber composition for a magnetic encoder comprising a fluorinated rubber with a Mooney viscosity (ML1+10, 121° C.) of 20 to 100 and a magnetic powder, said magnetic powder being blended in a proportion of 230 to 1900 parts by weight relative to 100 parts by weight of the fluorinated rubber.

2. The rubber composition for the magnetic encoder according to claim 1, wherein the proportion of blending of the magnetic powder is 400 to 1000 parts by weight relative to 100 parts by weight of the fluorinated rubber.

3. The rubber composition for the magnetic encoder according to claim 1, wherein the magnetic powder is blended to the rubber composition for the magnetic encoder in a proportion of 70 to 95 percent by weight.

4. The rubber composition for the magnetic encoder according to claim 2, wherein the magnetic powder is blended to the rubber composition for the magnetic encoder in a proportion of 70 to 95 percent by weight.

5. The rubber composition for the magnetic encoder according to claim 1, wherein the magnetic powder is a rare earth magnet powder.

6. The rubber composition for the magnetic encoder according to claim 2, wherein the magnetic powder is a rare earth magnet powder.

7. The rubber composition for the magnetic encoder according to claim 3, wherein the magnetic powder is a rare earth magnet powder.

8. The rubber composition for the magnetic encoder according to claim 5, wherein the rare earth magnetic powder is a magnetic powder containing at least neodymium-iron-boron powder.

9. The rubber composition for the magnetic encoder according to claim 6, wherein the rare earth magnetic powder is a magnetic powder containing at least neodymium-iron-boron powder.

10. The rubber composition for the magnetic encoder according to claim 7, wherein the rare earth magnetic powder is a magnetic powder containing at least neodymium-iron-boron powder.

11. The rubber composition for the magnetic encoder according to claim 5, wherein the rare earth magnetic powder is a magnetic powder containing at least samarium-iron-nitrogen powder.

12. The rubber composition for the magnetic encoder according to claim 6, wherein the rare earth magnetic powder is a magnetic powder containing at least samarium-iron-nitrogen powder.

13. The rubber composition for the magnetic encoder according to claim 7, wherein the rare earth magnetic powder is a magnetic powder containing at least samarium-Iron-nitrogen powder.

14. The rubber composition for the magnetic encoder according to claim 1, wherein the residual magnetic flux density is 300 mT or more.

15. The rubber composition for the magnetic encoder according to claim 3, wherein the residual magnetic flux density is 300 mT or more.

16. The rubber composition for the magnetic encoder according to claim 5, wherein the residual magnetic flux density is 300 mT or more.

17. A magnetic encoder vulcanized and molded from the magnetic rubber composition for the magnetic encoder according to claim 1.

18. A magnetic encoder vulcanized and molded from the magnetic rubber composition for the magnetic encoder according to claim 3.

19. A magnetic encoder vulcanized and molded from the magnetic rubber composition for the magnetic encoder according to claim 5.

20. The magnetic encoder according to claim 17, used for a rotation speed sensor.
